(19) United States
(12) Patent Application Publication
(10) Pub. No.: US 2025/0039940 A1
(43) Pub. Date: Jan. 30, 2025

(54) CONFIGURATION OF REPETITIONS OF DOWNLINK CONTROL INFORMATION

(71) Applicant: Nokia Technologies Oy, Espoo (FI)

(72) Inventors: Alessio MARCONE, Munich (DE); Arman AHMADZADEH, Munich (DE); Frank FREDERIKSEN, Aalborg (DK); Bo BI, Hangzhou (CN)

(21) Appl. No.: 18/758,638

(22) Filed: Jun. 28, 2024

(30) Foreign Application Priority Data
Jul. 28, 2023 (WO) PCT/CN2023/109979

(51) Int. Cl. H04W 74/0833; H04W 72/0446; H04W 72/0453; H04W 72/231

(52) U.S. Cl. CPC H04W 74/0833; H04W 72/0446; H04W 72/0453; H04W 72/231

(57) ABSTRACT

Embodiments of the present disclosure relate to apparatuses, methods, and computer readable storage media for a configuration of repetitions of downlink control information (DCI). The method comprises: receiving, from a second apparatus, a configuration of an random access (RA) search space; determining an additional RA search space including repetitions of physical downlink control channel (PDCCH) candidates of at least one monitoring occasion of the RA search space; and monitoring downlink control information at least based on the configuration of the RA search space and the repetitions in the additional RA search space.

### FIELDS

Various example embodiments of the present disclosure generally relate to the field of telecommunication and in particular, to methods, devices, apparatuses and computer readable storage medium for a configuration of repetitions of downlink control information (DCI).

### BACKGROUND

The study of non-terrestrial network (NTN) had focused on the applicability of the solutions developed by general new radio (NR) coverage enhancement to NTN, and identifying potential issues and enhancements, considering the NTN characteristics including large propagation delay and satellite movement.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, a configuration of a random access (RA) search space; determine an additional RA search space including repetitions of physical downlink control channel (PDCCH) candidates of at least one monitoring occasion of the RA search space; and monitor downlink control information at least based on the configuration of the RA search space and the repetitions in the additional RA search space.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, a configuration of an RA search space; and transmit, to the first apparatus, downlink control information, at least based on the configuration of the RA search space and repetitions of PDCCH candidates of at least one monitoring occasion of the RA search space included in an additional RA search space.

In a third aspect of the present disclosure, there is provided a method. The method comprises: receiving, from a second apparatus, a configuration of an RA search space; determining an additional RA search space including repetitions of PDCCH candidates of at least one monitoring occasion of the RA search space; and monitoring downlink control information at least based on the configuration of the RA search space and the repetitions in the additional RA search space.

In a fourth aspect of the present disclosure, there is provided a method. The method comprises: transmitting, to a first apparatus, a configuration of an RA search space; and transmitting, to the first apparatus, downlink control information, at least based on the configuration of the RA search space and repetitions of PDCCH candidates of at least one monitoring occasion of the RA search space included in an additional RA search space.

In a fifth aspect of the present disclosure, there is provided a first apparatus. The first apparatus comprises means for receiving, from a second apparatus, a configuration of an RA search space; means for determining an additional RA search space including repetitions of PDCCH candidates of at least one monitoring occasion of the RA search space; and means for monitoring downlink control information at least based on the configuration of the RA search space and the repetitions in the additional RA search space.

In a sixth aspect of the present disclosure, there is provided a second apparatus. The second apparatus comprises means for transmitting, to a first apparatus, a configuration of an RA search space; and means for transmitting, to the first apparatus, downlink control information, at least based on the configuration of the RA search space and repetitions of PDCCH candidates of at least one monitoring occasion of the RA search space included in an additional RA search space.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIGS. 2A-2D illustrate schematic diagrams of monitoring occasions (MOs), respectively;

FIG. 3 illustrates a signaling chart for communication according to some example embodiments of the present disclosure;

FIGS. 4A-4E illustrate schematic diagrams of MOs for PDCCH repetitions according to example embodiments of the present disclosure;

FIG. 5 illustrates a flowchart of a method implemented at a first device according to some example embodiments of the present disclosure;

FIG. 6 illustrates a flowchart of a method implemented at a second device according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “common search space (CSS)” may refer to a search space (i.e., a set of channel elements) that every UE needs to search for signals for every UE or signaling message that is applied to every UE before dedicated channel is established for a specific UE. The term “a repetition factor” used herein may refer a number of repetitions. The term “bitmap” used herein may refer to a string including binary number. The term “monitoring occasion (MO)” used herein may refer to a set of resources that is used for monitoring.

As described above, NTN work item had focused on the applicability of the solutions developed by general NR coverage enhancement to NTN. The work item may be consisted of a preliminary study phase, where the coverage performance of the different UL and DL channels was assessed, and where the bottleneck channels were identified.

Such identification finally leads to the detailed objectives including: to specify PUCCH enhancements for message 4 (Msg4) hybrid automatic repeat request (HARQ)-acknowledgement (ACK) (e.g., repetition) and to study demodulation reference signal (DMRS) bundling for physical uplink shared channel (PUSCH) taking into account NTN-specifics (e.g., time-frequency pre-compensation).

Furthermore, for the objective of UL enhancements, i.e., on enhancements of the Msg4 HARQ-ACK and enhancements to the DMRS bundling framework for PUSCH. During the work item phase, it has been discussed that the scope of the Msg4 HARQ-ACK should be expanded to also cover cases for PUCCH transmissions of HARQ-ACK when dedicated PUCCH resources have not been configured (of course only targeted UEs supporting the PUCCH repetition).

However, it has also been observed that some DL channels need enhancements as well, which concludes that when considering satellite power limitations (due to for example regulatory requirements or power split among the beams of the satellite), the channels related to initial access may need to be enhanced.

Along these lines, simulation results for the PDCCH channel performance are generated and the following conclusions are derived:

TABLE 1

| | AL1 | AL2 | AL4 | AL8 | AL16 |
|---|---|---|---|---|---|
| SNR at 1% BLER | 3.8 | −0.4 | −3.5 | −6.5 | −8.8 |
| from LLS | | | | | |
| Link budget SNR | −0.78 | −0.78 | −0.78 | −0.78 | −0.78 |
| w/o PFD limit | | | | | |
| SNR gap w/o PFD | −4.58 | −0.38 | 2.72 | 5.72 | 8.02 |
| limit | | | | | |
| SNR gap w/ PFD | −20.8 | −16.6 | −13.5 | −10.5 | −8.2 |
| limit | | | | | |

When considering satellite power limitations (due to for example regulatory requirements or power split among the beams of the satellite), the channels related to initial access need to be enhanced. In some solutions, when considering Power Flux Density (PFD) limits or more generically limits on satellite output power, coverage enhancements for the PDCCH channel are necessary.

In general, for improving coverage, there are three fundamental approaches that can be considered. These are: (a) lowering the interference and noise contributions (not relevant for this use case), (b) increasing the transmission power (not possible for this use case due to the PFD limits), and (c) increasing the energy per bit (through either reducing the payload or by transmitting over longer time). The latter is typically achieved by introducing repetitions of the channel to be enhanced. The repetition of Type0A/1/2/3 CSS (common search space) and USS (UE specific search space) PDCCH has been specified for the multi-TRP feature and its mechanism could be extended for NTN, at least for the PDCCH channels in RRC connected mode. The repetition feature, however, does not apply to the PDCCH in initial access and, specifically, to the Type1-PDCCH configured.

For improving the physical layer performance of a physical layer control channel, the approach that is typically used is to assign a larger number of resources for transmission of a certain number of bits. One approach to achieve this is to repeat the transmitted data (that is a given data or control channel) multiple times, to give the possibility to a receiver to combine the received signals and improve the reliability of the demodulated and decoded bits.

Based on this, one of the methods that could be followed in the enhancements of the coverage of the Type1-PDCCH, would be to repeat the Type1-PDCCH multiple times in a same or different slot, and thereby allow a UE receiver to combine the received Type1-PDCCH single transmissions and improve the reliability of the received information.

However, in order to be able to combine the multiple Type1-PDCCH repetitions, it is necessary for the UE to know at least if and how many repetitions are being transmitted by the gNB, and hence the time span of the Type1-PDCCH repetitions. For this reason, methods for configuration of a Type1-PDCCH with repetitions are necessary.

Therefore, some example embodiments of the present disclosure propose a solution for a configuration of repetitions of DCI. In particular, a network device transmits a configuration of a RA search space to terminal device. The terminal device determines an additional RA search space including repetitions of PDCCH candidates of at least one monitoring occasion of the RA search space. The terminal device 110 further monitors downlink control information at least based on the configuration of the RA search space and the repetitions in the additional RA search space.

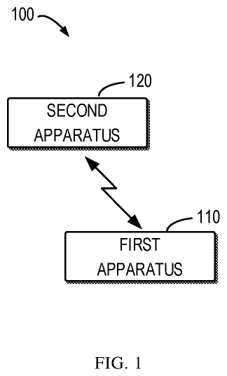

FIG. 1 shows an example communication network 100 in which embodiments of the present disclosure may be implemented. As shown in FIG. 1, the communication network 100 may include a first apparatus 110. Hereinafter the first apparatus 110 may also be referred to as a UE or a terminal device.

The communication network 100 may further include a second apparatus 120. Hereinafter the second apparatus 120 may also be referred to as a gNB or a network device. The first apparatus 110 may communicate with the second apparatus 120.

It is to be understood that the number of network devices and terminal devices shown in FIG. 1 is given for the purpose of illustration without suggesting any limitations. The communication network 100 may include any suitable number of network devices and terminal devices.

In some example embodiments, links from the second apparatus 120 to the first apparatus 110 may be referred to as a downlink (DL), while links from the first apparatus 110 to the second apparatus 120 may be referred to as an uplink (UL). In DL, the second apparatus 120 is a transmitting (TX) device (or a transmitter) and the first apparatus 110 is a receiving (RX) device (or receiver). In UL, the first apparatus 110 is a TX device (or transmitter) and the second apparatus 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The second apparatus 120 may transmit the PDCCH using resource elements (REs) that belong to a control resource set (CORESET). In particular, frequency allocation of PDCCH and the length of PDCCH (1 to 3 symbols) may be determined based on the corresponding configuration of CORESET (ControlResourceSet information element (IE)), which is shown in table 2 below.

TABLE 2
ControlResourceSet information element

-- ASN1START
-- TAG-CONTROLRESOURCESET-START

| ControlResourceSet ::= | SEQUENCE { | |
|---|---|---|
| controlResourceSetId | ControlResourceSetId, | |
| frequencyDomainResources | BIT STRING (SIZE (45) ), | |
| duration | INTEGER (1..maxCoReSetDuration), | |
| cce-REG-Mappingtype | CHOICE { | |
| interleaved | SEQUENCE { | |
| reg-BundleSize | ENUMERATED (n2, n3, n6), | |
| interleaverSize | ENUMERATED (n2, n3, n6), | |
| shiftIndex | INTEGER (0..max@ofPhysicalResourceBlocks-1) | OPTIONAL -- Need S |
| }, | | |
| [symbol] Interleaved | NULL | |
| }, | | |
| precoderGranularity | ENUMERATED (sameAsREG--bundle, allContiguousRBs), | |
| tci-StatesPDCCH-ToAddList | SEQUENCE (SIZE (1..maxNrofTCI-StatesPDCCH)) | OPTIONAL, -- Cond NotSIB-initialBWP |
| | OF ICI-StateId | |
| tci-StatesPUCCH-ToReleaseList | SEQUENCE (SIZE (1..maxNrofTCI-StatesPUCCH)) | OPTIONAL, -- Cond NotSIB-initialBWP |
| | OF ICI-StateId | |
| tci-PresentInDCI | ENUMERATED (enabled} | OPTIONAL, -- Need S |
| pdcch-DMRS-ScramblingID | INTEGER (0..65535) | OPTIONAL, -- Need S |

```
  ...,
  [ [
```

| | | |
|---|---|---|
| rb-Offset--r16 | INTEGER (0..5) | OPTIONAL, -- Need S |
| tci-PresentDCI-1-2-r16 | INTEGER (1..3) | OPTIONAL, -- Need S |
| coresetPoolIndex-r16 | INTEGER (0..1) | OPTIONAL, -- Need S |
| controlResourceSetId-v1610 | ControlResourceSetId-v1610 | OPTIONAL -- Need S |

] ],

[ [

| | | |
|---|---|---|
| followUnifiedTCI-State-r17 | ENUMERATED (enabled) | OPTIONAL --- Need [symbol] |

] ]
}
-- TAG-CONTROLRESOURCESET-STOP
-- ASN1STOP [symbol]
indicates data missing or illegible when filed

While the frequency location of PDCCH and the length of PDCCH is configured by CORESET, potential instances of time where the first apparatus 110 expects to monitor, and blindly perform multiple decoding attempts per monitoring occasion (MOs), of the PDCCH may be determined by the search space (SS) set. Generally, SS sets can be categorized as common search space (CSS) set, that is common for a group of UEs, and UE specific search space (USS) set, which is UE specific. Type1-PDCCH may be transmitted in a CSS set that is used by UE to blindly decode DCI formats 1_0 scheduling message 2 (MSG2) and message 4 (MSG4) in random access procedure. Having said that, SearchSpace IE is shown in table 3.

TABLE 3
SearchSpace information element

| | | |
|---|---|---|
| -- ASN1START | | |
| -- TAG-SEARCHSPACE-START | | |
| SearchSpace := | SEQUENCE { | |
| searchSpaceId | SearchSpaceId, | |
| controlResourceSetId | ControlResourceSetId | OPTIONAL, -- Cond SetupOnly |
| monitoringSlotPeriodicityAndOffset | CHOICE { | |
| s11 | NULL, | |
| s12 | INTEGER {0..1}, | |
| s14 | INTEGER {0..3}, | |
| s15 | INTEGER {0..4}, | |
| s18 | INTEGER {0..7}, | |
| s110 | INTEGER {0..9}, | |
| s116 | INTEGER {0..15}, | |
| s120 | INTEGER {0..19}, | |
| s140 | INTEGER {0..39}, | |
| s180 | INTEGER {0..79}, | |
| s1160 | INTEGER {0..159}, | |
| s1320 | INTEGER {0..319}, | |
| s1640 | INTEGER {0..639}, | |
| s11280 | INTEGER {0..1279}, | |
| s12560 | INTEGER {0..2559} | |
| } | | OPTIONAL, -- Cond Setup4 |
| duration | INTEGER (2..2559) | OPTIONAL , -- Need S |
| monitoringSymbolsWithinSlot | BIT STRING {SIZE (14) } | OPTIONAL, -- Cond Setup |
| nrofCandidates | SEQUENCE { | |
| aggregationLevel1 | ENUMERATED {n0, n1, n2, n3, n4, n5, n6, n8}, | |
| aggregation Level2 | ENUMERATED {n0, n1, n2, n3, n4, n5, n6, n8}, | |
| aggregation Level4 | ENUMERATED {n0, n1, n2, n3, n4, n5, n6, n8}, | |
| aggregation Level8 | ENUMERATED {n0, n1, n2, n3, n4, n5, n6, n8}, | |
| aggregationLevel16 | ENUMERATED {n0, n1, n2, n3, n4, n5, n6, n8}, | |
| } | | OPTIONAL, -- Cond Setup |
| searchSpaceType | CHOICE { | |
| common | SEQUENCE { | |
| dci-Format0-0-AndFormat1-0 | SEQUENCE { | |
| ... | | |
| } | | OPTIONAL, -- Need R |
| dci-Format2-0 | SEQUENCE { | |
| nrofCandidates-SFI | SEQUENCE { | |
| aggregationLevel1 | ENUMERATED {n1 n2} | OPTIONAL, -- Need R |
| aggregationLevel2 | ENUMERATED {n1 n2} | OPTIONAL, -- Need R |
| aggregationLeve14 | ENUMERATED {n1, n2} | OPTIONAL, -- Need R |
| aggregationLeve18 | ENUMERATED {n1, n2} | OPTIONAL, -- Need R |
| aggregationLevel16 | ENUMERATED {n1, n2} | OPTIONAL -- Need R |
| }, | | |
| ... | | |
| } | | OPTIONAL, -- Need R |
| dci-Format2-1 | SEQUENCE { | |
| ... | | |
| } | | OPTIONAL, -- Need R |

Every SS set may be associated with a certain ControlResourceSetID. Additionally, a parameter “monitoringSlotPeriodicityAndOffset” may determine the periodicity (with a certain starting offset) of the slots, where the first apparatus 110 expects to monitor PDCCH within SS set, i.e., where the PDCCH might be sent by the second apparatus 120.

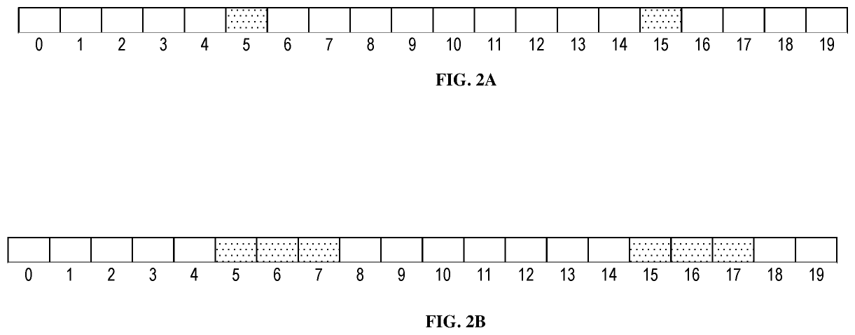

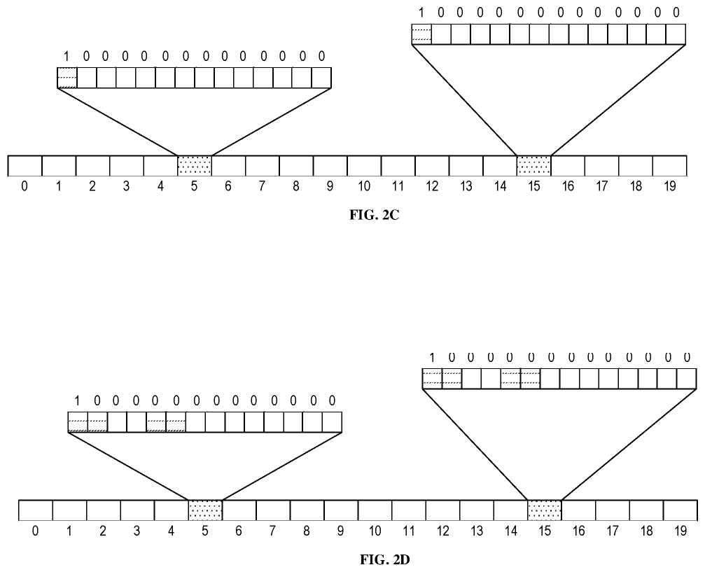

In an example embodiment (called as example 1), as shown in FIG. 2A, assuming that subcarrier spacing (SCS) is equal to 30 kHz (20 slots per frame), and the parameter “monitoringSlotPeriodicityAndOffset” is set to S110 with offset 5, then the first apparatus 110 may expect to monitor PDCCH in MOs with slot number 5 and 15.

Furthermore, the parameter “duration” in search space IE may provide information regarding the consecutive number of slots where a synchronization signal (SS) exists/lasts in every occasion as given by the periodicity and offset. In particular, if the field of the parameter “duration” is absent, the first apparatus 110 may apply the value 1 slot, except for DCI format 2_0. The first apparatus 110 may ignore this field for DCI format 2_0. The maximum valid duration may be periodicity−1 (periodicity as given in the parameter “monitoringSlotPeriodicityAndOffset”).

For SCS 480 kHz and SCS 960 kHz, duration-r17 is used, and the configured duration may be restricted to be an integer multiple of L slots and smaller than periodicity, where L is the configured length of the bitmap monitoring Slots WithinSlotGroup-r17. If duration-r17 is absent, the first apparatus 110 may assume the duration in slots is equal to L. The maximum valid duration is periodicity-L.

In another example embodiment (called as example 2), as shown in FIG. 2B, assuming that subcarrier spacing (SCS) is equal to 30 kHz (20 slots per frame), the parameter “monitoringSlotPeriodicityAndOffset” is set to S110 with offset 5 the parameter “duration” is set to 3, the first apparatus 110 may expect that every occasion exists/lasts 3 slots, and the corresponding MOs may be slots 5, 6, 7, 15, 16, and 17.

Moreover, the parameter “monitoringSymbolsWithinSlot” configured by the second apparatus 120, which is a bit string of size 14 may determine PDCCH location (on an OFDM symbol level) within MO slot. For example, the parameter “monitoringSymbolsWithinSlot” may define first symbol(s) for PDCCH monitoring in the slots configured for (multi-slot) PDCCH monitoring (see monitoringSlotPeriodicity AndOffset and duration). The most significant (left) bit may represent the first OFDM in a slot, and the second most significant (left) bit may represent the second OFDM symbol in a slot and so on. The bit(s) set to one identify the first OFDM symbol(s) of the control resource set within a slot.

In the previous two examples, the MOs on a slot-level granularity for simplicity is depicted, whereas within every MO slot, actual MO starts from an OFDM symbol indicated by the bitmap “monitoringSymbolsWithinSlot” and has a duration equal to the duration of CORESET. Let us consider one example which shows MOs on a OFDM symbol-level.

In another example embodiment, based on the assumptions of example 1, as shown in FIG. 2C, wherein “monitoringSymbolsWithinSlot” is set to a bit map [10000000000000], with CORESET duration of 1 OFDM symbol. Then first apparatus 110 expects to monitor PDCCH in the MOs starts at the 1^{st} OFDM symbol of slot number 5 and 15.

In a further example embodiment, based on the assumptions of example 1, as shown in FIG. 2D, wherein “monitoringSymbolsWithinSlot” is set to a bit map [10001000000000], with CORESET duration of 2 OFDM symbols. Then the first apparatus 110 expects to monitor PDCCH in the MOs start at the 1^{st} and 5th OFDM symbols of slot numbers 5 and 15.

Example embodiments of the present disclosure will be described in detail below with reference to the accompanying drawings.

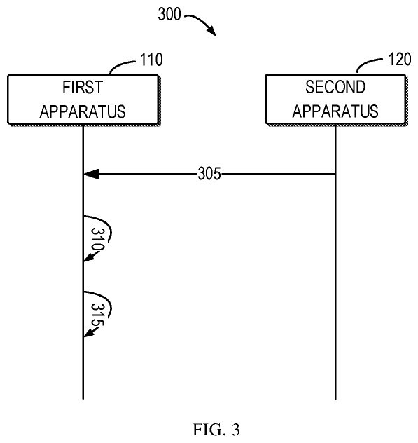

Reference is now made to FIG. 3, which shows a signaling chart 300 for communication according to some example embodiments of the present disclosure. As shown in FIG. 3, the signaling chart 300 involves a first apparatus 110 and a second apparatus 120. For the purpose of discussion, reference is made to FIG. 1 to describe the signaling chart 300.

The second apparatus 120 transmit (305) a synchronization signal block (SSB) to the first apparatus 110. The first apparatus 110 may perform a frequency band search, read the SSB and acquire master information block (MIB). Then the first apparatus 110 may obtain the resources needed for reading system information block 1 (SIB1) from the MIB.

In some embodiments, the second apparatus 120 may configure an RA search space (which may also be called as an original RA search space) and an additional search space. For example, the additional RA search space may be configured only for Rel-19 enhanced UEs. In this case, parameters of the additional RA search space may be directly configured by the second apparatus 120.

In some other embodiments, the additional RA search space may be autonomously determined by the first apparatus 110, based on the original RA search space. For example, parameters of the additional RA search space may be derived from the parameters of the original RA search space based on scaling factors.

For example, the scaling factors may be specified or configured by the second apparatus 120, i.e., the second apparatus 120 may not configure the additional RA search space but configure scaling factors with which the first apparatus 110 may determine the additional RA search space from the original RA search space.

Furthermore, the scaling factors may depend on the satellite architecture, such as altitude, orbit, etc., and first apparatus 110 may select one scaling factor from a set of configured or specified scaling factors.

Then the first apparatus 110 may determine (310) an additional RA search space containing repetitions of PDCCH candidates of monitoring occasion of the RA search space (i.e., the original one) for enhanced detection of DCI 1_0 with CRC scrambled by either the RA Radio Network Temporary Identifier (RA-RNTI) or the Temporary Cell-RNTI (TC-RNTI) and monitor (315) the DCI at least based on the configuration of the RA search space and the repetitions in the additional RA search space.

In a case where both the RA search space and the additional RA search space are configured by the second apparatus 120, the second apparatus 120 transmits SIB1 with “PDCCH-ConfigCommon” IE configuring two Type1-PDCCH CSS sets, each set may be with parameter “ra-SearchSpace” for specifying the identity number of the corresponding Type1-PDCCH CSS set and every corresponding CSS set may be configured with “SearchSpace” IE with corresponding configuration parameters, such as SCS, “monitoringSlotPeriodicityAndOffset”, duration, “monitoringSymbols WithinSlot”, etc.

In some embodiments, the number and location (e.g., slot) of the Monitoring Occasions (MOs) of the additional RA search space are the same as the number and location of the MOs of the original RA search space.

In this case, each MO in the original RA search space has a repetition MO in the additional RA search space and each PDCCH candidate within the MOs in the original RA search space has a repetition PDCCH candidate in the additional RA search space.

In some other embodiments, the number and location (e.g., slot) of the MOs of the additional RA search space may be different from (e.g., smaller than) the number and location of the MOs of the original RA search space. In this case, a subset of MOs (and all PDCCH candidates of the subset of MOs) in the original RA search space are repeated, i.e., the additional RA search space includes MOs for the repetition of subset of MOs in the original RA search space. The subset of MOs in the original RA search space may be considered as one or more specific MOs in the original RA search space.

For example, the subset of MOs in the original RA search space to be repeated are determined at the first apparatus 110 either via specifications or via network configuration.

In some embodiment, in the case of network configuration, a bitmap could be used on the monitoring occasions of the original RA search space to indicate which specific monitoring occasions are repeated. The bitmap may have slot-level granularity and may have a size equal to the value of the configured duration parameter for the original RA search space or a size equal to the number of slots in one frame. The bitmap may have symbol-level granularity and may have a size equal to the value of the configured duration parameter for the original RA search space scaled by the number of symbols per slot or a size equal to the number of symbols in one frame.

In some embodiment, in the case of network configuration, the additional RA search space could be configured by the second apparatus and the first apparatus would monitor for PDCCH repetitions in the corresponding MOs.

In some embodiment, a bitmap could be used to indicate which of the monitoring occasions within one slot are repeated, and the bitmap applies to the MOs of the original search space.

In some embodiment, the second apparatus 120 may transmit the enhanced PDCCH in the subset of MOs in the original RA search space and in the repeated MOs in the additional RA search space. For example, a specific RA-RNTI values are used to address enhanced UEs (i.e., UEs able to receive PDCCH repetitions). The second apparatus 120 may transmit DCIs scrambled with such RA-RNTI values in the specific monitoring occasions in the original RA search space and in the repeated monitoring occasions in the additional RA search space. The remaining MOs in the original RA search space may be used by the second apparatus 120 for transmission of non-enhanced PDCCH.

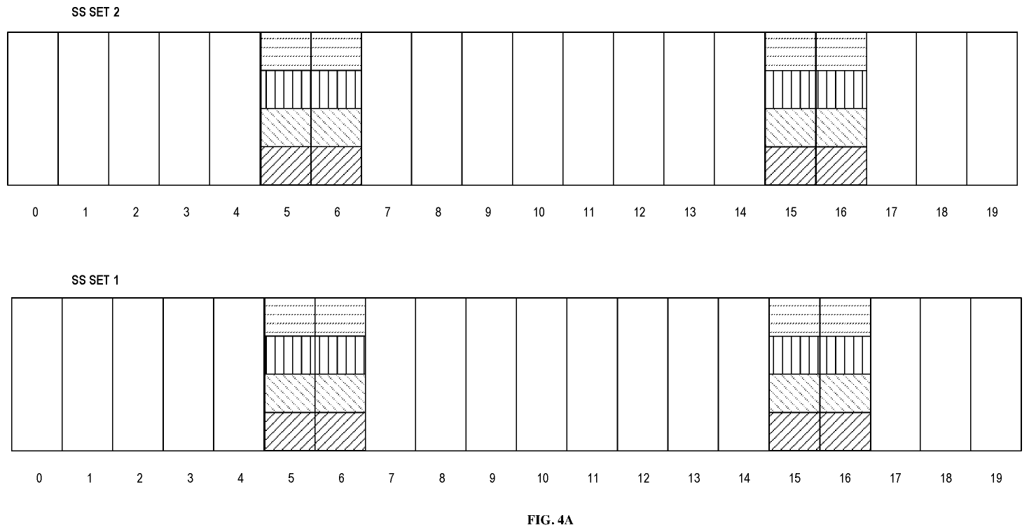

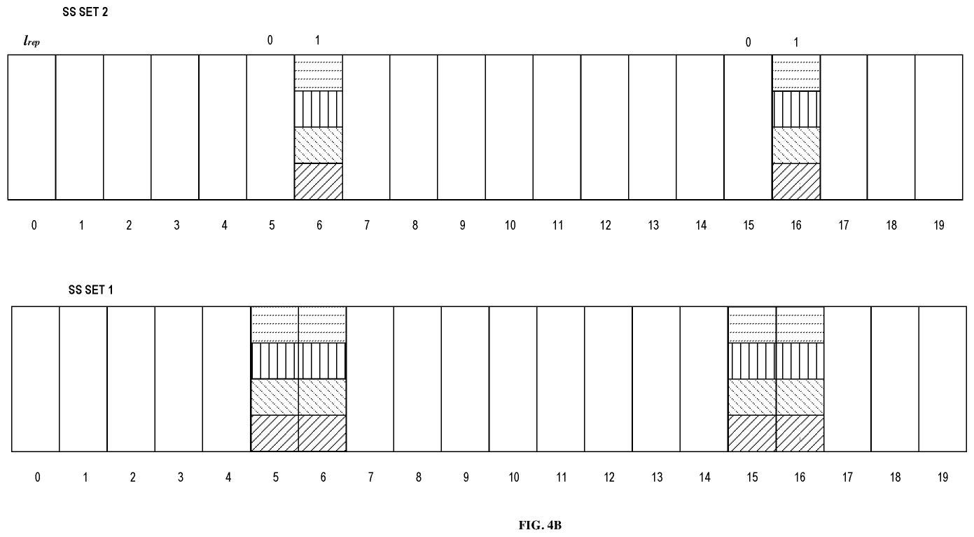

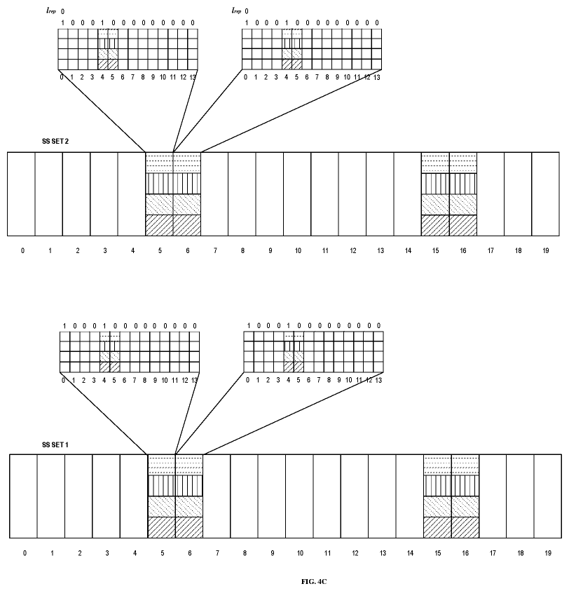

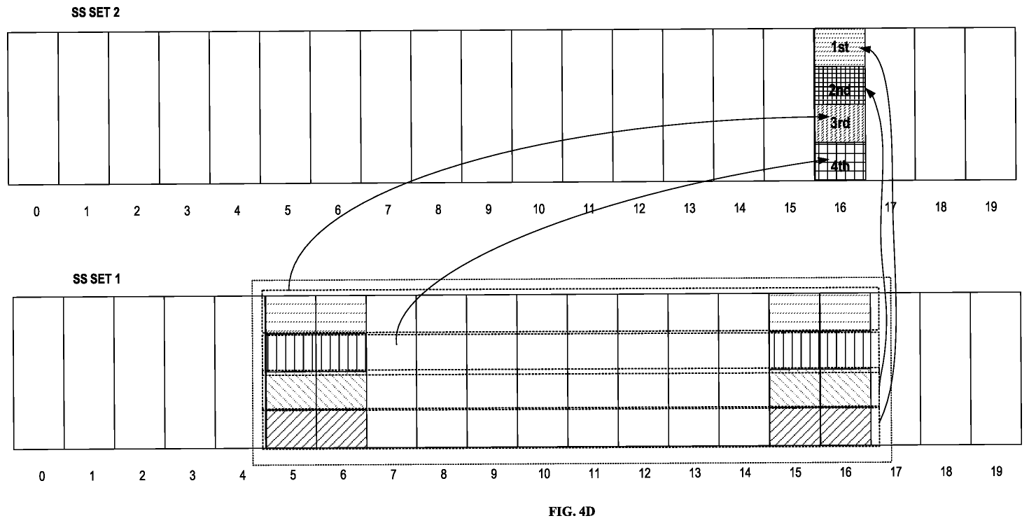

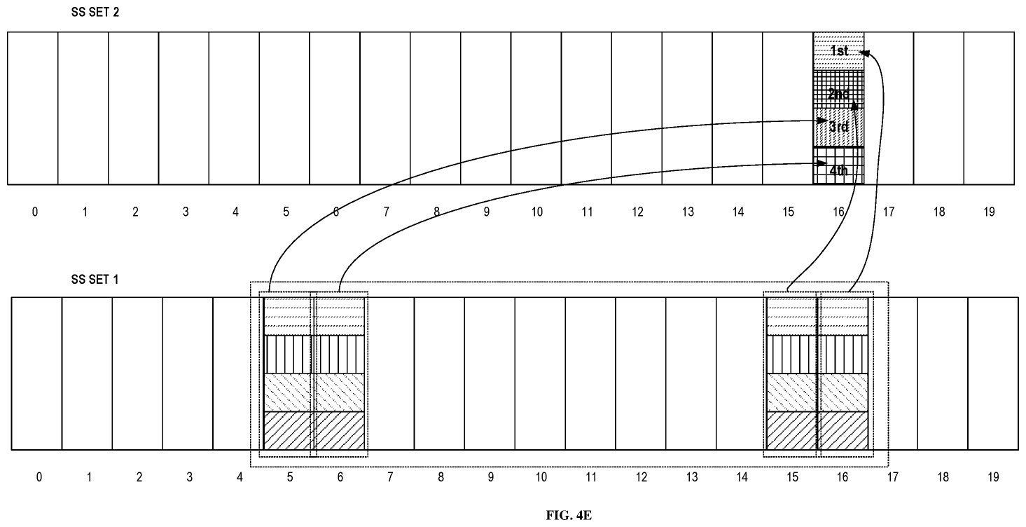

For the case where the number and location of the MOs of the additional RA search space are the same as the number and location of the MOs of the original RA search space, FIG. 4A shows an example of MOs (on slot level in a frame at 30 KHz SCS) of a UE with repetition capability. Only one MO is shown per MO slot in FIG. 4A, but the example would equally be valid also for the case where multiple MOs are present in one MO slot, wherein MO slot is defined as the slot wherein one or more MO(s) can be found. The parameters of the additional RA search space configured by the apparatus 120 may be assumed to be as: “monitoringSlotPeriodicityAndOffset”=S110 with offset 5, “duration” is set to 2.

The first apparatus 110 with repetition capability may acquire the repetition factor as 2 and considers repetitions MOs in the additional RA search space (i.e., SS set 2 in FIG. 4A).

As shown in FIG. 4A, each MO of MO slots (slots 5, 6, 15 and 16 with one MO, in this example) in the original RA search space (i.e., SS set 1) has a repetition MO in the same slot in the additional RA search space (i.e., SS set 2) and each PDCCH candidate within the MOs in the original RA search space (i.e., SS set 1) has a repetition PDCCH candidate in the additional RA search space (i.e., SS set 2).

Then first apparatus 110 with repetition capability may receive PDCCH and PDCCH repetition in one of the MOs in the original RA search space and additional RA search space, respectively.

For the case where the number and location of the MOs of the additional RA search space are smaller than the number and location of the MOs of the original RA search space, FIG. 4B shows an example of MOs (on slot level in a frame at 30 KHz SCS) of a UE with repetition capability. Only one MO is shown per MO slot in FIG. 4A, but the example would equally be valid also for the case where multiple MOs are present in one MO slot, wherein MO slot is defined as the slot wherein one or more MO(s) can be found. In the example shown in FIG. 4B, the number of MOs in additional RA search space (i.e., SS set 2) is smaller than the number of MOs in the original RA search space (i.e., SS set 1).

In this example, the first apparatus 110 may be indicated with parameters of additional RA search space, i.e., monitoringSlotPeriodicityAndOffset=S110 with offset 6, “duration” is set to 1, In this example, additionally or alternatively, the second apparatus 120 may indicate, via a bitmap, which one of the MOs in the original RA search space (i.e., SS set 1) is repeated in the additional RA search space (i.e., SS set 2), with a slot-level granularity, i.e., any bit set to “1” within the bit map indicates all MOs in the corresponding slot in the original RA search space (i.e., SS set 1) is repeated in the additional RA search space (i.e., SS set 2).

For example, the second apparatus 120 may indicate repetitions MOs via a bitmap lᵣₑₚ, wherein lᵣₑₚ has a length equal to the number of MO slots within a frame or, more generically, within a reference time period and a bit “1” indicates that an MO within original RA search space (i.e., SS set 1) is repeated in the additional RA search space (i.e., SS set 2). For instance, for the considered parameters in the example shown in FIG. 4B, within one frame, MO slots are slots 5, 6, 15, and 16. Therefore, lᵣₑₚ has a length of 4. Here, we assume lᵣₑₚ=[0101]. In another example, in case the reference time period is one duration, for the considered parameters in the example shown in FIG. 4B, within one duration (set to 2 slots) there are 2 MO slots (i.e. {5, 6} or {15, 16}). Therefore, rep has a length of 2. Here, we assume lᵣₑₚ=[01], and equally applies to all durations.

As shown, the first apparatus 110 may consider all MOs in slot 6 and all MOs in slot 16 in the original RA search space (i.e., SS set 1) to have their corresponding repetition MOs in additional RA search space (i.e., SS set 2).

In the example of FIG. 4B, the bitmap specifying repetitions MOs had slot-level granularity. It is also possible that a bitmap is with symbol-level granularity. In other words, for every MO slot determined by periodicity and offset, the corresponding MOs (determined by parameter “monitoringSymbolsWithinSlot”) within that slot may be configured to have their repetition MOs in the additional RA search space. Here, the bit map lᵣₑₚ may have a length equal to the number of “1”s in “monitoringSymbols WithinSlot” or a length equal to the number of symbols in one or more slots.

FIG. 4C shows another example of MOs of the UE with repetition capability. In this example, the difference of parameters between this example and the examples shown in FIG. 4B is that now “monitoringSymbolsWithinSlot” is set to [10001000000000], i.e., two MOs are present per MO slot, Cand CORESET has a duration of two OFDM symbols.

Furthermore, the second apparatus 120 may indicate repetitions MOs via the bit map lᵣₑₚ, wherein lᵣₑₚ has a length equal to the number of 1's in the parameter “monitoringSymbolsWithinSlot”, which is set to set to [10001000000000], i.e., in this example lᵣₑₚ has a length of two. Here, assuming that lᵣₑₚ=[01], i.e., from the two MOs within every MO slot, only the second one has corresponding repetition MO in the additional RA search space (i.e., SS set 2).

In some embodiments, the number and location (e.g., slot) of the MOs of the additional RA search space is smaller than the number and location of the MOs of the original RA search space, and the MOs of the additional RA search space include PDCCH candidates of one or multiple MOs of the original RA search space.

In other words, since only specific PDCCH candidates (e.g., carrying DCI scrambled with specific RA-RNTI) need to be repeated, PDCCH candidates that need to be repeated from a same or different MOs of the original RA search space can be grouped together and repeated in one MO of the additional RA search space.

In this case, the group of PDCCH candidates that need to be repeated from a same or different MOs of the original RA search space may be called as a PDCCH candidate group.

The PDCCH candidate group may include PDCCH candidates from a number of MOs of the original RA search space, which may be determined at the first apparatus 110 via specification or configuration.

FIGS. 4D and 4E still another examples of MOs (on slot level) of the UE with repetition capability. In both examples, it is considered that an MO in additional RA search space has the repetitions candidates of a group of PDCCH candidates of one or multiple MOs in the original RA search space.

In particular, the time-domain location of the MO in additional RA search space may be determined by a hard-coded rule in the specification or to be configured by NW (for example, the second apparatus 120). Here the second apparatus 120 is assumed to configure the MO in additional RA search space.

In both examples, parameters of additional RA search space may be similar to the examples shown in FIG. 4A. Additionally, the second apparatus 120 may configure/indicate the MO in the additional RA search space (i.e., SS set 2) that carries the repetition PDCCH candidate(s) of group of PDCCH candidates in a number of MOs in the original RA search space (i.e., SS set 1), e.g., group of PDCCH candidates in MO slots 5, 6, 15, and 16.

In this situation, one sample configuration may be to have relative configuration with respect to original RA search space. For instance, the second apparatus 120 may indicate that the MO in the additional RA search space (i.e., SS set 2) corresponds to the last MO in the original RA search space (i.e., SS set 1) within every frame. Another sample configuration may be based on periodicity and offset, for instance, the additional RA search space (i.e., SS set 2) may be configured with periodicity S120 and offset 16. Both of the sample configurations above may lead to the same MO in the additional RA search space (i.e., SS set 2).

FIG. 4D shows an example, it is considered that an MO in additional RA search space contains PDCCH candidates which are repetitions of a group of PDCCH candidates of multiple MOs in the original RA search space (i.e., of a PDCCH candidate group). In this example, a PDCCH candidate group is formed of the PDCCH candidates with same index of all MOs within a frame. In FIG. 4D it is assumed that one MO slot contains only one MO, but the same example could be extended to the case of multiple MO within one MO slot. The group of 1^{st} PDCCH candidates within all MOs (e.g., the first MOs in slot 5, 6, 15 and 16) in the original RA search space (i.e., SS set 1) is mapped to the 3^{rd} candidate in the additional RA search space (i.e., SS set 2), the group of 2^{nd} PDCCH candidates within all Mos (e.g., the second MOs in slot 5, 6, 15 and 16) in the original RA search space (i.e., SS set 1) is mapped to the 4th candidate in the additional RA search space (i.e., SS set 2), the group of 3^{rd} PDCCH candidates within all MOs (e.g., the third MOs in slot 5, 6, 15 and 16) in the original RA search space (i.e., SS set 1) is mapped to the 2^{nd} candidate in the additional RA search space (i.e., SS set 2) and the group of 4th PDCCH candidates within all MOs (e.g., the fourth MOs in slot 5, 6, 15 and 16) in the original RA search space (i.e., SS set 1) is mapped to the 1^{st}. candidate in the additional RA search space (i.e., SS set 2).

It is to be understood that only one PDCCH candidate of the PDCCH candidate group can be actually repeated by the second apparatus 120 in the one PDCCH candidate in the additional RA search space, but the first apparatus 110 may blindly try the combination of all of them until something is detected. For example, if the 1^{st} PDCCH candidate group is mapped to the 1^{st} PDCCH candidate in the additional RA search space, and the 1^{st} PDCCH candidate group has four PDCCH candidates, UE may blindly try to combine all the PDCCH candidates within the 1^{st} PDCCH candidate group with the 1^{st} candidate in the additional RA search space until something is detected.

In the example of FIG. 4E, a mapping pattern may be based on MO indices in the original RA search space (i.e., SS set 1): 1^{st} MO (slot 5) in the original RA search space (i.e., SS set 1) is mapped to 3^{rd} candidate in the additional RA search space (i.e., SS set 2), 2^{nd} MO (slot 6) in the original RA search space (i.e., SS set 1) is mapped to 4th candidate in the additional RA search space (i.e., SS set 2), 3^{rd} MO (slot 15) in the original RA search space (i.e., SS set 1) is mapped to 2^{nd} candidate in the additional RA search space (i.e., SS set 2) and 4th MO (slot 16) in the original RA search space (i.e., SS set 1) is mapped to 1^{st} candidate in the additional RA search space (i.e., SS set 2). It is to be understood that, if each MO in the original RA search space contain multiple PDCCH candidate, only one PDCCH candidate can be actually repeated by the second apparatus in the one PDCCH candidate in the additional RA search space, but the first apparatus may blindly try the combination of all of them until something is detected. For example, if the 1^{st} MO in slot 5 in the original RA search space is mapped to the 3^{rd} candidate in the additional RA search space, and the 1^{st} MO in slot 5 in the original RA search space has two PDCCH candidates, UE may blindly try to combine the 1^{st} and 2^{nd} PDCCH candidate of the 1^{st} MO in the original RA search space with the 3^{rd} candidate in the additional RA search space until something is detected.

With the example, the number of blind decoding attempts at the first apparatus 110 can be reduced, as there is a one-to-one mapping between MO in original RA search space and repetition candidate in the additional RA search space.

Based on embodiments of the present disclosure, the multiple Type1-PDCCH repetitions can be combined, and the UE would know if and how many repetitions are being transmitted by the NW. In this way, the coverage of the Type1-PDCCH can be enhanced.

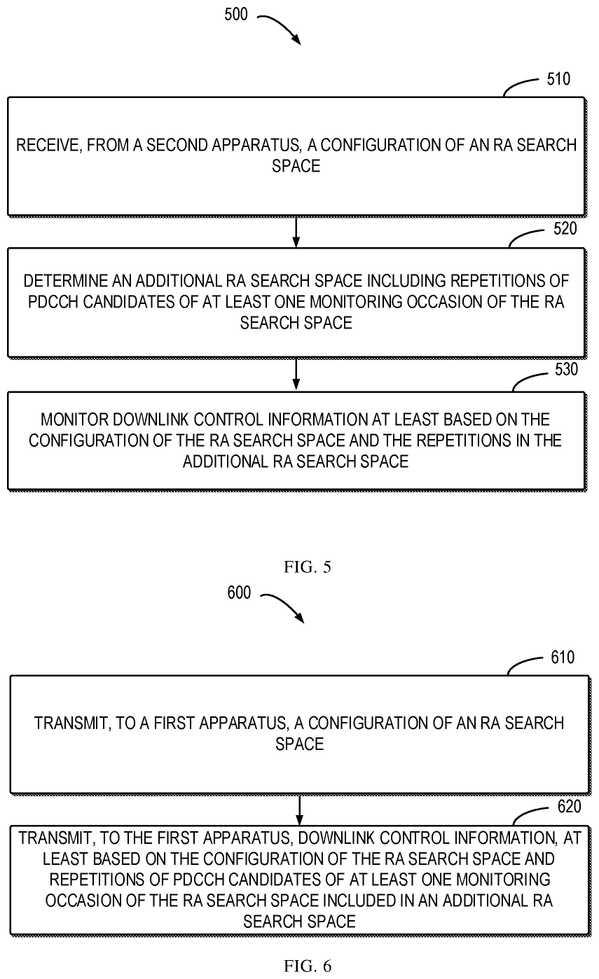

FIG. 5 shows a flowchart of an example method 500 implemented at a first device in accordance with some example embodiments of the present disclosure. For the purpose of discussion, the method 500 will be described from the perspective of the first apparatus 110 in FIG. 1.

At block 510, the first apparatus 110 receives, from a second apparatus, a configuration of an RA search space.

At block 520, the first apparatus 110 determines an additional RA search space including repetitions of PDCCH candidates of at least one monitoring occasion of the RA search space.

At block 530, the first apparatus 110 monitors downlink control information at least based on the configuration of the RA search space and the repetitions in the additional RA search space.

In some example embodiments, the method 500 further comprises: receiving, from the second apparatus, a configuration of the additional RA search space; and determining the additional RA search space based on the configuration of the additional RA search space.

In some example embodiments, the method 500 further comprises: determining parameters of the additional RA search space based on the configuration of parameters of the RA search space and a scaling factor.

In some example embodiments, the scaling factor is configured by a second apparatus or determined by the first apparatus based on parameters associated with a satellite architecture.

In some example embodiments, the number and location of at least one monitoring occasion of the additional RA search space is same as the number and location of the at least one monitoring occasion of the RA search space.

In some example embodiments, each monitoring occasion in the at least one monitoring occasions of the RA search space is linked to a monitoring occasion in the additional RA search space, and wherein each PDCCH candidate within each monitoring occasion in the at least one monitoring occasions of the RA search space has a repetition PDCCH candidate in the linked monitoring occasion in the additional RA search space.

In some example embodiments, the number and location of at least one monitoring occasion of the additional RA search space is different from the number and location of the at least one monitoring occasion of the RA search space.

In some example embodiments, a subset of monitoring occasions in the at least one monitoring occasion of the RA search space are to be repeated.

In some example embodiments, part or all of the PDCCH candidates in part or all of the monitoring occasions of the RA search space belongs to a PDCCH candidate group.

In some example embodiments, the PDCCH candidate group is to be repeated in at least one monitoring occasion of the additional RA search space.

In some example embodiments, the at least one monitoring occasion of the additional RA search space is located in one or more slots that are non-overlapped with one or more slots of the RA search space.

In some example embodiments, the at least one monitoring occasion of the additional RA search space is located in one or more slots that at least partially overlapped with one or more slots of the RA search space and wherein time-frequency resources associated with the additional RA search space in an overlapped slot are different from the time-frequency resources associated with the RA search space.

In some example embodiments, the method 500 further comprises: determining at least one overlapped slot based on at least one of the following: an offset and a periodicity of the additional RA search space, or a configuration of the RA search space.

In some example embodiments, the first apparatus comprises a terminal device and second apparatus comprises a network device.

FIG. 6 shows a flowchart of an example method 600 implemented at a second device in accordance with some example embodiments of the present disclosure. For the purpose of discussion, the method 600 will be described from the perspective of the second apparatus 120 in FIG. 1.

At block 610, the second apparatus 120 transmits, to a first apparatus, a configuration of an RA search space.

At block 620, the second apparatus 120 transmits, to the first apparatus, downlink control information, at least based on the configuration of the RA search space and repetitions of PDCCH candidates of at least one monitoring occasion of the RA search space included in an additional RA search space.

In some example embodiments, the method 600 further comprises: determining a configuration of the additional RA search space; and transmitting the configuration of the additional RA search space to the first apparatus.

In some example embodiments, the method 600 further comprises: transmitting, to the first apparatus, a scaling factor for the first apparatus to determine the additional RA search space based on the RA search space.

In some example embodiments, the number and location of at least one monitoring occasion of the additional RA search space is same as the number and location of the at least one monitoring occasion of the RA search space.

In some example embodiments, each monitoring occasion in the at least one monitoring occasions of the RA search space is linked to a monitoring occasion in the additional RA search space, and wherein each PDCCH candidate within each monitoring occasion in the at least one monitoring occasions of the RA search space has a repetition PDCCH candidate in the linked monitoring occasion in the additional RA search space.

In some example embodiments, the number and location of at least one monitoring occasion of the additional RA search space is different from the number and location of the at least one monitoring occasion of the RA search space.

In some example embodiments, a subset of monitoring occasions in the at least one monitoring occasion of the RA search space are to be repeated.

In some example embodiments, part or all of the PDCCH candidates in part or all of the monitoring occasions of the RA search space belongs to a PDCCH candidate group.

In some example embodiments, the PDCCH candidate group is to be repeated in at least one monitoring occasion of the additional RA search space.

In some example embodiments, the at least one monitoring occasion of the additional RA search space is located in one or more slots that are non-overlapped with one or more slots of the RA search space.

In some example embodiments, the at least one monitoring occasion of the additional RA search space is located in one or more slots that at least partially overlapped with one or more slots of the RA search space and wherein time-frequency resources associated with the additional RA search space in an overlapped slot are different from the time-frequency resources associated with the RA search space.

In some example embodiments, the first apparatus comprises a terminal device and second apparatus comprises a network device.

In some example embodiments, a first apparatus capable of performing any of the method 500 (for example, the first apparatus 110 in FIG. 1) may comprise means for performing the respective operations of the method 500. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a configuration of an RA search space; means for determining an additional RA search space including repetitions of PDCCH candidates of at least one monitoring occasion of the RA search space; and means for monitoring downlink control information at least based on the configuration of the RA search space and the repetitions in the additional RA search space.

In some example embodiments, the first apparatus further comprises: means for receiving, from the second apparatus, a configuration of the additional RA search space; and means for determining the additional RA search space based on the configuration of the additional RA search space.

In some example embodiments, the first apparatus further comprises: means for determining parameters of the additional RA search space based on the configuration of parameters of the RA search space and a scaling factor.

In some example embodiments, the scaling factor is configured by a second apparatus or determined by the first apparatus based on parameters associated with a satellite architecture.

In some example embodiments, the number and location of at least one monitoring occasion of the additional RA search space is same as the number and location of the at least one monitoring occasion of the RA search space.

In some example embodiments, each monitoring occasion in the at least one monitoring occasions of the RA search space is linked to a monitoring occasion in the additional RA search space, and wherein each PDCCH candidate within each monitoring occasion in the at least one monitoring occasions of the RA search space has a repetition PDCCH candidate in the linked monitoring occasion in the additional RA search space.

In some example embodiments, the number and location of at least one monitoring occasion of the additional RA search space is different from the number and location of the at least one monitoring occasion of the RA search space.

In some example embodiments, a subset of monitoring occasions in the at least one monitoring occasion of the RA search space are to be repeated.

In some example embodiments, part or all of the PDCCH candidates in part or all of the monitoring occasions of the RA search space belongs to a PDCCH candidate group.

In some example embodiments, the PDCCH candidate group is to be repeated in at least one monitoring occasion of the additional RA search space.

In some example embodiments, the at least one monitoring occasion of the additional RA search space is located in one or more slots that are non-overlapped with one or more slots of the RA search space.

In some example embodiments, the at least one monitoring occasion of the additional RA search space is located in one or more slots that at least partially overlapped with one or more slots of the RA search space and wherein time-frequency resources associated with the additional RA search space in an overlapped slot are different from the time-frequency resources associated with the RA search space.

In some example embodiments, the first apparatus further comprises: means for determining at least one overlapped slot based on at least one of the following: an offset and a periodicity of the additional RA search space, or a configuration of the RA search space.

In some example embodiments, the first apparatus comprises a terminal device and second apparatus comprises a network device.

In some example embodiments, the first apparatus further comprises means for performing other operations in some example embodiments of the method 500 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second apparatus 120 in FIG. 1 may comprise means for performing the respective operations of the method 600. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a configuration of an RA search space; and means for transmitting, to the first apparatus, downlink control information, at least based on the configuration of the RA search space and repetitions of PDCCH candidates of at least one monitoring occasion of the RA search space included in an additional RA search space.

In some example embodiments, the second apparatus further comprises: means for determining a configuration of the additional RA search space; and means for transmitting the configuration of the additional RA search space to the first apparatus.

In some example embodiments, the second apparatus further comprises: means for transmitting, to the first apparatus, a scaling factor for the first apparatus to determine the additional RA search space based on the RA search space.

In some example embodiments, the number and location of at least one monitoring occasion of the additional RA search space is same as the number and location of the at least one monitoring occasion of the RA search space.

In some example embodiments, each monitoring occasion in the at least one monitoring occasions of the RA search space is linked to a monitoring occasion in the additional RA search space, and wherein each PDCCH candidate within each monitoring occasion in the at least one monitoring occasions of the RA search space has a repetition PDCCH candidate in the linked monitoring occasion in the additional RA search space.

In some example embodiments, the number and location of at least one monitoring occasion of the additional RA search space is different from the number and location of the at least one monitoring occasion of the RA search space.

In some example embodiments, a subset of monitoring occasions in the at least one monitoring occasion of the RA search space are to be repeated.

In some example embodiments, part or all of the PDCCH candidates in part or all of the monitoring occasions of the RA search space belongs to a PDCCH candidate group.

In some example embodiments, the PDCCH candidate group is to be repeated in at least one monitoring occasion of the additional RA search space.

In some example embodiments, the at least one monitoring occasion of the additional RA search space is located in one or more slots that are non-overlapped with one or more slots of the RA search space.

In some example embodiments, the at least one monitoring occasion of the additional RA search space is located in one or more slots that at least partially overlapped with one or more slots of the RA search space and wherein time-frequency resources associated with the additional RA search space in an overlapped slot are different from the time-frequency resources associated with the RA search space.

In some example embodiments, the first apparatus comprises a terminal device and second apparatus comprises a network device.

In some example embodiments, the second apparatus further comprises means for performing other operations in some example embodiments of the method 600 or the second apparatus 120. In some example embodiments, the means comprises at least one processor; and at least one memory storing instructions that, when executed by the at least one processor, cause the performance of the second apparatus.

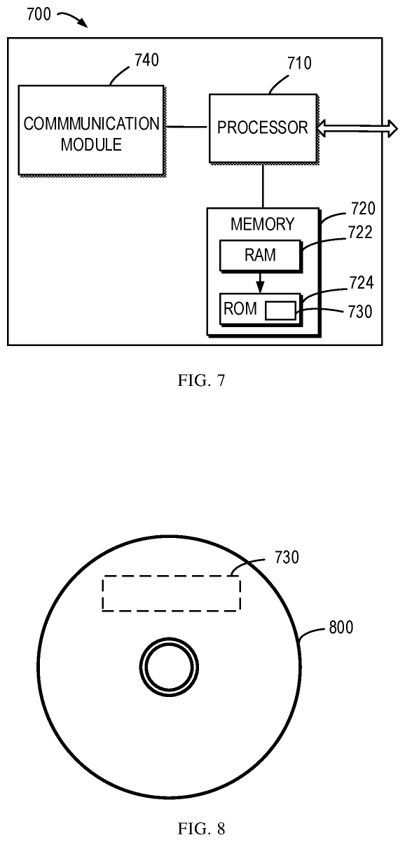

FIG. 7 is a simplified block diagram of a device 700 that is suitable for implementing example embodiments of the present disclosure. The device 700 may be provided to implement a communication device, for example, the first apparatus 110 or the second apparatus 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2A to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
receive, from a second apparatus, a configuration of a random access, RA, search space;
determine an additional RA search space including repetitions of physical downlink control channel, PDCCH, candidates of at least one monitoring occasion of the RA search space; and
monitor downlink control information at least based on the configuration of the RA search space and the repetitions in the additional RA search space.

2. The first apparatus of claim 1, wherein the first apparatus is caused to:
receive, from the second apparatus, a configuration of the additional RA search space; and
determine the additional RA search space based on the configuration of the additional RA search space.

3. The first apparatus of claim 1, wherein the first apparatus is caused to:
determine parameters of the additional RA search space based on the configuration of parameters of the RA search space and a scaling factor.

4. The first apparatus of claim 3, wherein the scaling factor is configured by a second apparatus or determined by the first apparatus based on parameters associated with a satellite architecture.

5. The first apparatus of claim 1, wherein the number and location of at least one monitoring occasion of the additional RA search space is same as the number and location of the at least one monitoring occasion of the RA search space.

6. The first apparatus of claim 5, wherein each monitoring occasion in the at least one monitoring occasions of the RA search space is linked to a monitoring occasion in the additional RA search space, and wherein each PDCCH candidate within each monitoring occasion in the at least one monitoring occasions of the RA search space has a repetition PDCCH candidate in the linked monitoring occasion in the additional RA search space.

7. The first apparatus of claim 1, wherein the number and location of at least one monitoring occasion of the additional RA search space is different from the number and location of the at least one monitoring occasion of the RA search space.

8. The first apparatus of claim 7, wherein a subset of monitoring occasions in the at least one monitoring occasion of the RA search space are to be repeated.

9. The first apparatus of claim 7, wherein part or all of the PDCCH candidates in part or all of the monitoring occasions of the RA search space belongs to a PDCCH candidate group.

10. The first apparatus of claim 9, wherein the PDCCH candidate group is to be repeated in at least one monitoring occasion of the additional RA search space.

11. The first apparatus of claim 7, wherein the at least one monitoring occasion of the additional RA search space is located in one or more slots that are non-overlapped with one or more slots of the RA search space.

12. The first apparatus of claim 7, wherein the at least one monitoring occasion of the additional RA search space is located in one or more slots that at least partially overlapped with one or more slots of the RA search space and wherein time-frequency resources associated with the additional RA search space in an overlapped slot are different from the time-frequency resources associated with the RA search space.

13. The first apparatus of claim 12, wherein the first apparatus is caused to:
determine at least one overlapped slot based on at least one of the following:
an offset and a periodicity of the additional RA search space, or
a configuration of the RA search space.

14. The first apparatus of claim 1, wherein the first apparatus comprises a terminal device and second apparatus comprises a network device.

15. A second apparatus comprising:
at least one processor; and
at least one memory storing instructions that, when executed by the at least one processor, cause the second apparatus at least to:
transmit, to a first apparatus, a configuration of a random access, RA, search space; and
transmit, to the first apparatus, downlink control information, at least based on the configuration of the RA search space and repetitions of physical downlink control channel, PDCCH, candidates of at least one monitoring occasion of the RA search space included in an additional RA search space.

16. The second apparatus of claim 15, wherein the second apparatus is caused to:
determine a configuration of the additional RA search space; and
transmit the configuration of the additional RA search space to the first apparatus.

17. The second apparatus of claim 15, wherein the second apparatus is caused to:
transmit, to the first apparatus, a scaling factor for the first apparatus to determine the additional RA search space based on the RA search space.

18. The second apparatus of claim 15, wherein the number and location of at least one monitoring occasion of the additional RA search space is same as the number and location of the at least one monitoring occasion of the RA search space.

19. The second apparatus of claim 18, wherein each monitoring occasion in the at least one monitoring occasions of the RA search space is linked to a monitoring occasion in the additional RA search space, and wherein each PDCCH candidate within each monitoring occasion in the at least one monitoring occasions of the RA search space has a repetition PDCCH candidate in the linked monitoring occasion in the additional RA search space.

20. A method comprising:
receiving, at a first apparatus and from a second apparatus, a configuration of an RA search space;
determining an additional RA search space including repetitions of PDCCH candidates of at least one monitoring occasion of the RA search space; and
monitoring downlink control information at least based on the configuration of the RA search space and the repetitions in the additional RA search space.
